(19) United States
(12) Patent Application Publication
(10) Pub. No.: US 2007/0095349 A1
(43) Pub. Date: May 3, 2007

(54) Respiratory mask

(75) Inventors: Hans-Ulrich Hansmann, BARNITZ (DE); Gotz Kullik, Lubeck (DE); Jorg-uwe Meyer, Ratzeburg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DRAGERWERK AG, LUBECK (DE)

(21) Appl. No.: 10/580,751

(22) PCT Filed: Oct. 5, 2004
(86) PCT No.: PCT/EP04/11125

§ 371 Date: Oct. 23, 2006

(30) Foreign Application Priority Data
Nov. 28, 2003 (DE) 103 55 752.0

(51) Int. Cl. A62B 18/02

(52) U.S. Cl. 128/206.21; 128/205.29; 128/206.24

(57) ABSTRACT

The invention relates to a respiratory mask comprising a mask body (2), a sealing edge (3) and an inhalation device. Said device can be improved such that gas can be evacuated from the inhalation device without noise disturbance. The aim of the invention is achieved by virtue of the fact that the inhalation device comprises a plurality of lamella-type, partially overlapping membrane elements (8) which can be unfolded by the respiratory gas flow and which are arranged on the mask body (2).

### FIELD OF THE DISCLOSURE

The present disclosure relates to a respiratory mask with a mask body and an exhalation system.

### BACKGROUND OF THE DISCLOSURE

A respiratory mask of the type mentioned is known from U.S. Pat. No. 4,971,051. It is made up of a mask body with an inhalation opening and an exhalation opening and is secured on the mask wearer's face by means of a strap. The seal between face and mask body is effected by a sealing edge that extends about the periphery of the mask body. With a compressed gas source connected to the inhalation opening, a continuous flow of respiratory gas at a constant overpressure is generated in the interior of the mask, in order to be able to perform CPAP (continuous positive airway pressure) ventilation.

A disadvantage of the known respiratory mask is that the continuous escape of gas from the exhalation opening is associated with a not inconsiderable noise level, which cannot be tolerated, especially when the respiratory mask is used in a domestic setting. An example of such an application is in the treatment of sleep apnea.

### SUMMARY OF THE DISCLOSURE

One aspect of the invention is to improve a respiratory mask of this type in such a way that gas can escape from the exhalation opening without causing any appreciable noise disturbance.

One advantage of the disclosed respiratory mask is mainly that, by means of a large number of membrane elements disposed on the mask body, a large surface area is obtained for the discharge of the expiratory gas and of the basic gas flow required for CPAP ventilation, with the result that a stream of gas at low speed is possible.

By virtue of the geometry of the membrane elements and the interplay between inherent elasticity and porosity, a specific pneumatic resistance can be set, from which it is possible to ensure a defined basic pressure in the interior of the mask for CPAP ventilation. By changing the physical characteristics of the membrane elements, an individual mask can be produced for each CPAP pressure and can be attached to a nonspecific high-pressure source via the inhalation opening, the excess gas being able to flow outward through the membrane elements.

The mask specified according to the disclosure can be produced from flat, lightweight material with minimal packaging and it therefore has good wearing properties. The membrane elements can be joined together as strip-shaped components to form a cloth construction, the rigidity being able to be influenced by integrated titanium-nickel filaments.

A sealing edge disposed between the mask body and the face of the mask wearer is made of soft, comfortable elastomer material which adapts well to the shape of the face. If the mask body is made of resilient material, the sealing edge can be supported by a stiff but formable frame. In addition to simple metal frames, it is also advantageous to use a construction based on shape-memory alloys which at low temperatures, for example when stored for a short time in a freezer compartment, permit a plastic deformation.

The membrane elements are advantageously designed as flow channels delimited by membrane strips, the flow channels being arranged in a matrix pattern on the mask body. A specific CPAP pressure in the respiratory mask can be set via the spring rigidity of the membrane strips and the diameter, length and number of the flow channels.

An alternative advantageous embodiment involves parallel membrane films which are provided with openings and can also be connected to one another in the form of a multilayer woven fabric. The flow resistance of the membrane material can be influenced via the diameter and the number of the openings.

Advantageously, the membrane elements are disposed as partially overlapping lamellas on the mask body and through which the expired air can flow. During the passage of the expired gas, the membrane elements are partially or even completely folded open. The basic pressure in the mask interior can be influenced via the number and geometry of the membrane elements and their spring rigidity.

Advantageously, the membrane elements are designed in the form of bendable bars secured at one end, the securing positions lying in the overlap area of the membrane elements. The membrane elements can in this case be affixed to a porous support material and are folded open by the flow of gas passing through the support material.

The membrane material is advantageously composed of a textile fabric or an elastomer, and the material can be partially or completely gas-permeable.

To influence the spring rigidity of the material, a material component can be integrated which directly changes its mechanical geometry, similarly to electro-rheological liquids, as a result of electric signals. The membrane elements can, however, also be composed entirely of the material component.

It is also advantageously possible to use, as membrane material, a PVDF film whose rigidity can be altered by electric fields. By this electrical influence of the spring rigidity, it is possible to achieve electrical modulation of the respiratory gas flow. In this way, the respiratory mask according to the disclosure is also suitable for forms of breathing with different CPAP pressure stages and for mechanical or spontaneous ventilation assistance.

An illustrative embodiment of the disclosure is shown in the figures and explained in greater detail below.

### BRIEF DESCRIPTION OF THE DRAWINGS

FIG. 1 shows a first respiratory mask according to the disclosure in longitudinal section,

FIG. 2 shows the detail A according to FIG. 1, without gas flowing through,

FIG. 3 shows the detail A according to FIG. 1, with gas flowing through,

FIG. 4 shows a second respiratory mask according to the disclosure in longitudinal section,

FIG. 5 shows the detail B according to FIG. 4,

FIG. 6 shows the detail B according to FIG. 4 with narrowed flow channels,

FIG. 7 shows the detail B with membrane films,

FIG. 8 shows the detail B with membrane films connected to a voltage source.

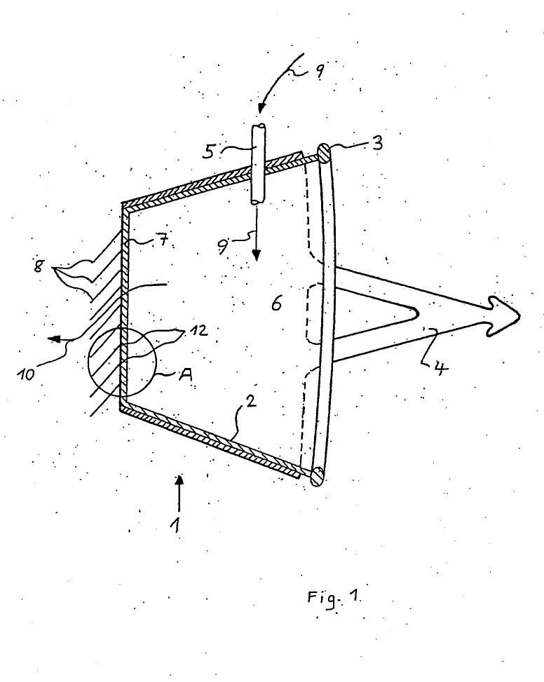

FIG. 1 is a schematic representation of a first respiratory mask 1 according to the disclosure in longitudinal section. A peripheral sealing edge 3 is located on a mask body 2 and bears on the face of a mask wearer (not shown in FIG. 1). The first respiratory mask 1 is fixed on the mask wearer's head by means of a strap 4, shown only in part in FIG. 1. The respiratory gas passes into the interior 6 of the mask via an inhalation opening 5. On the front of the mask body 2 there is a gas-permeable support material 7 on which strip-shaped membrane elements 8 arranged as lamellas and in the form of bendable bars are secured at securing positions 12.

FIG. 1 illustrates the membrane elements 8 in the state in which gas flows through the first respiratory mask 1, in which state the membrane elements 8 are lifted from the support material 7 by the gas flow. The direction of flow is indicated by arrows 9, 10.

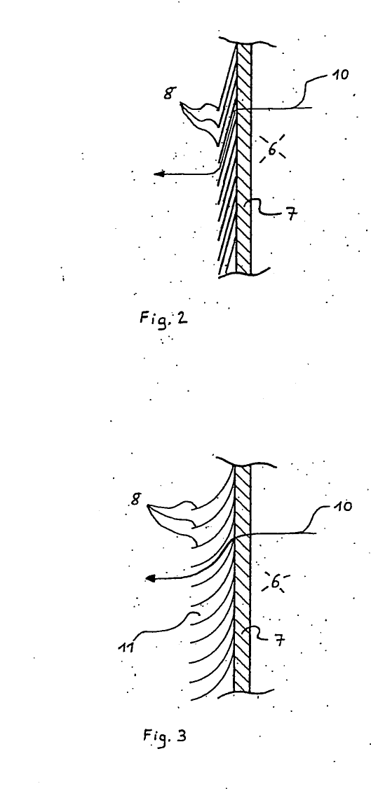

FIG. 2 illustrates the detail A according to FIG. 1 for a respiratory mask 1 through which no gas is flowing. The membrane elements 8 in this case lie on one another in an overlapping manner, such that the support material 7 is covered by the membrane elements 8 and no gas can pass from the environment into the interior 6 of the mask. Identical components are provided with the same reference numbers as in FIG. 1.

FIG. 3 illustrates the detail A according to FIG. 1 in the case where gas is flowing through the support material 7 in the direction of the arrow 10. The membrane elements 8 are deformed here as bendable bars, in such a way that flow channels 11 form between adjacent membrane elements 8. The cross section of the flow channels 11 and, consequently, the pressure in the interior 6 of the mask can be influenced via the spring rigidity of the membrane elements 8.

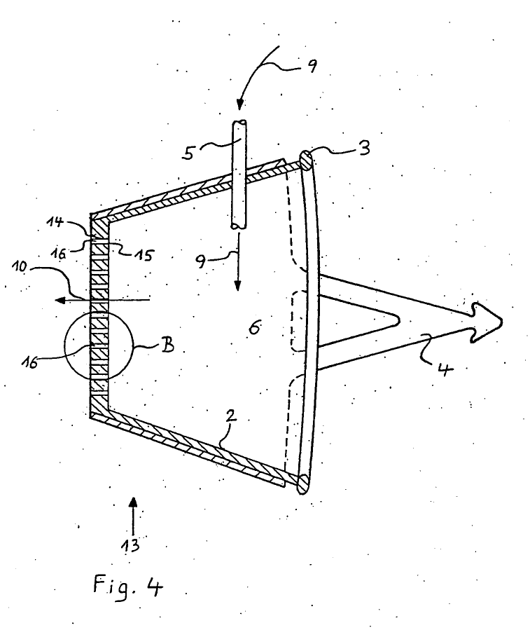

FIG. 4 illustrates a second protective respiratory mask 13 in which the exhalation system is composed of a large number of flow channels 16 delimited by membrane strips 14, 15. The flow channels 16 are distributed in a matrix pattern across the front of the mask body 2. The membrane strips 14, 15 are connected to an electrical voltage source by means of which the aperture size of the flow channels 16 can be changed. Identical components are provided with the same reference numbers as in FIG. 1.

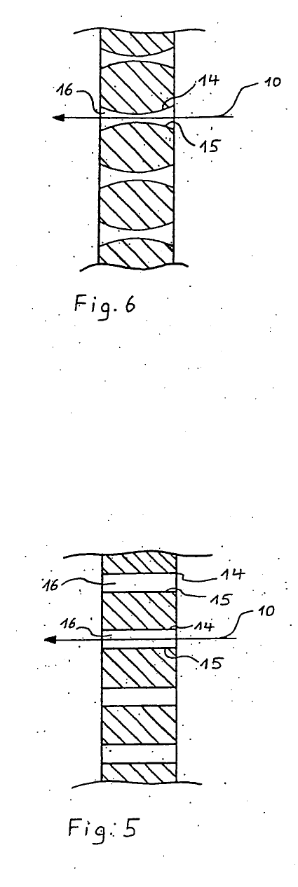

For improved clarity, FIG. 5 illustrates an enlarged view of the flow channels 16 in section B according to FIG. 4. Identical components are provided with the same reference numbers as in FIG. 4.

FIG. 6 shows narrowed flow channels 16 in the section B according to FIG. 4, resulting from a voltage source (not shown in FIG. 6) being connected to the membrane strips 14, 15.

In an alternative embodiment of the second protective respiratory mask 13, parallel membrane films 17 are arranged in the area of the exhalation opening and are provided with individual openings 18 arranged in a matrix formation.

FIG. 7 is a schematic illustration of the membrane films 17 in section B according to FIG. 4. The membrane films 17 are depicted schematically in FIG. 7. They can also be constructed in the form of a multi-layer woven fabric.

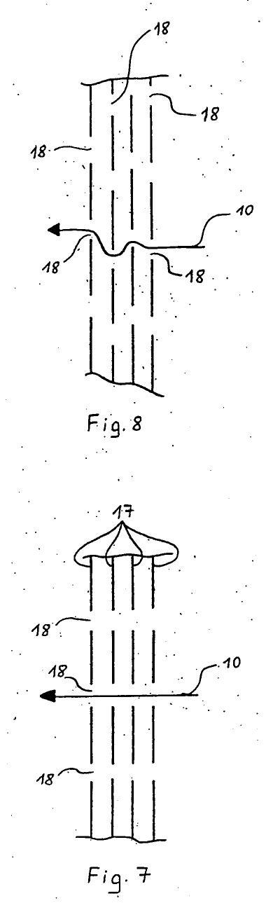

By means of a voltage source (not shown here), the membrane films 17 can be altered in terms of their distance from one another or in terms of their length, as a result of which a vertical offset is obtained between the openings 18, as is illustrated in FIG. 8. The arrow 10 indicates an example of the direction of flow through the membrane films 17. The flow resistance can be altered via the offset of the openings 18 from one another and via the number of membrane films 17

1. A respiratory mask, comprising:
a mask body; and
an exhalation system including a large number of membrane elements which are disposed on the mask body and through which expired air can flow.

2. The respiratory mask as claimed in claim 1, wherein the membrane elements are designed as flow channels delimited by membrane strips.

3. The respiratory mask as claimed in claim 2, wherein the flow channels are arranged in a matrix pattern on the mask body.

4. The respiratory mask as claimed in claim 1, wherein the membrane elements are designed as parallel membrane films which are provided with openings.

5. The respiratory mask as claimed in claim 4, wherein the membrane films are connected to one another in the form of a multilayer woven fabric.

6. The respiratory mask as claimed in claim 1, wherein the membrane elements are designed in the form of bendable bars secured at one end.

7. The respiratory mask as claimed in claim 6, wherein the bendable bars include securing positions lying in an overlap area of the membrane elements.

8. The respiratory mask as claimed in claim 1, wherein the membrane material is composed of a textile fabric or an elastomer.

9. The respiratory mask as claimed in claim 1, wherein the membrane material is selected from a group of materials which change their geometry as a result of electric fields.

10. The respiratory mask as claimed in claim 1, wherein the membrane material is selected from a group of materials which change their spring rigidity as a result of electric fields.

11. The respiratory mask as claimed in claim 9, wherein the material is a PVDF film.

12. Use of a material which, as a result of electric fields, changes its geometry or spring rigidity in the region of the exhalation system of a protective respiratory mask as a flow resistance element for influencing the flow of expired air.
